(19) United States
(12) Patent Application Publication
(10) Pub. No.: US 2024/0278484 A1
(43) Pub. Date: Aug. 22, 2024

(54) THIN FILM PAINTS AND METHODS OF APPLICATION ON CORNERS

(71) Applicant: ENTROTECH, INC., Columbus, OH (US)

(72) Inventor: Shane Michael Scott, Columbus, OH (US)

(73) Assignee: ENTROTECH, INC., Columbus, OH (US)

(21) Appl. No.: 18/560,977

(22) PCT Filed: May 23, 2022
(86) PCT No.: PCT/US2022/030604

§ 371 Date: Nov. 15, 2023

Related U.S. Application Data
(60) Provisional application No. 63/191,862, filed on May 21, 2021.

(51) Int. Cl. B29C 63/00; B29C 63/02; B29L 7/00; B29L 31/30

(52) U.S. Cl. CPC B29C 63/0026; B29C 63/0047; B29C 63/0065; B29C 2063/021; B29L 2007/008; B29L 2031/3005

(57) ABSTRACT

Methods of applying a paint film on a substrate may include adhering a corner patch on at least a portion of a corner of the substrate and adhering a paint film sheet on the substrate such that the corner is within a corner relief pattern of the paint film sheet. The corner relief pattern may correspond to a recess along an edge of the paint film sheet. The paint film sheet may partially overlap with and bond with the corner patch, thereby providing a continuous paint film over at least the corner of the substrate. Cosmetic paint films configured for adhering onto an exterior panel of a motor vehicle are also provided.

### CROSS-REFERENCE TO RELATED APPLICATIONS

This application claims the benefit of U.S. Provisional Patent Application No. 63/191,862, filed May 21, 2021, the entire disclosure of which is incorporated by reference herein.

### INCORPORATION BY REFERENCE

All publications and patent applications mentioned in this specification are herein incorporated by reference in their entirety to the same extent as if each individual publication or patent application was specifically and individually indicated to be incorporated by reference.

### BACKGROUND

In recent years, paint films have gained popularity as an alternative to traditional surface painting methods in many different types of applications, especially motorized vehicles such as automobiles, airplanes, and boats. This popularity is at least partially a result of the paint films being more durable and sustainable compared to traditional paint.

One exemplary paint film is the Aero Satin clean 200 film, which is a clear film used to change the surface of a vehicle. These films and methods of manufacturing are described in U.S. Publication No. 20190161646, the entirety of which is incorporated by reference herein.

In general, the application of the paint film involves covering a substrate with a thin sheet of material and allowing the thin sheet of material to adhere to the surfaces of the substrate, thereby forming a protecting coating. Certain features of the substrate, such as sharp corners and edges, may be challenging to cover in a way that provides a smooth and blended-appearing coating. This is, in part, due to the planar shape of the paint film compared to the three-dimensional nature of the corner and edges of the substrate.

As an example, FIG. 10 illustrates a paint film sheet 600 on a corner portion of a substrate. The paint film sheet 600 includes a simple relief cut 601 to accommodate the corner tip 604 of the substrate. This is of the type typically used when installing paint film on a corner a car hood part or similar automotive body panel. As shown, the simple relief cut 601 is a straight cut that runs straight across from one side of the corner to the other. Note the exposed substrate/underlying hood color is easily seen, which detracts from the paint films aesthetic appearance. Even when relief cut 601 is positioned as close as possible toward the corner tip 604, at least some of the corner tip 604 is left exposed, as shown, leaving the corner tip 604 unprotected from the elements. Adjusting the paint film sheet 600 position such that the relief cut 601 is farther toward the corner tip 604 may cause the paint film sheet 600 to bunch up or wrinkle, resulting in a cosmetically unacceptable coating at the corner tip 604. Another option could be to pull the paint film sheet 600 toward the apex of the corner tip 604 such that paint film sheet 600 deforms to cover the corner tip 604. However, this can thin the paint film sheet 600 at the region of the corner tip 604, forming a high stress point, and a potential point of failure, of the paint film sheet 600 at the corner tip 604.

It would be beneficial to have paint films and methods that can minimize cosmetic and functional defects at corners and other topological features of a substrate surface.

### SUMMARY

Described herein are improved methods of applying a paint film on substrate, especially on corners or other high aspect ratio features of a substrate.

In general, in one embodiment, a method of applying a paint film on a substrate includes forming a relief pattern cut along an edge a paint film sheet to accommodate a corner or other surface feature of the substrate, applying a patch made of the same material as the paint film on the corner or surface feature of the substrate, and applying the paint film on the substrate such that the paint film overlaps and is brought into sufficient intimate contact with the patch to bond with the patch, thereby providing a continuous paint film over the corner or other surface feature. At least one of the paint film and the patch is nominally very thin such that the overlap between the two films can be visibly unapparent.

As used herein, a “corner” of a substrate can refer to a location or region of the substrate at which two or more surfaces of the substrate intersect. An angle at which at least two of the surfaces intersect may define an angle of the corner. The paint films and methods described herein may be used to provide a protective paint coating on corners having any angle. For example, the corner may be an acute angle (less than 90 degrees), a right angle (90 degrees), an obtuse angle (>90 degrees), or a reflex angle (>180 degrees).

The paint films and methods described herein may be used to provide a protective coating to features other than corners. For example, a substrate may include a protrusion or a recess that would be difficult to cover with a paint film in a manner that results in a smooth, continuous, and appealing appearing coating. The paint film application techniques may be used to provide a smooth, continuous, and appealing appearing coating over such difficult to coat protrusions or recesses.

According to some aspects, a method of applying a paint film on a substrate is described, the method including: adhering a corner patch on at least a portion of a corner of the substrate; and adhering a paint film sheet on the substrate such that the corner is within a corner relief pattern of the paint film sheet, the corner relief pattern corresponding to a recess along an edge of the paint film sheet, wherein paint film sheet partially overlaps with and bonds with the corner patch, thereby providing a continuous paint film over at least the corner of the substrate. The corner patch may be a paint film that is made of a same material as the paint film sheet. The corner patch may have a first thickness, and the paint film sheet has a second thickness, wherein the first thickness is less than the second thickness. A ratio of the first thickness relative the second thickness may range between 1:4 and 3:4. The first thickness may range between 100-500 microns, and the second thickness may range between 50 and 200 microns. Adhering the paint film sheet on the substrate may include applying pressure along a surface of the paint film sheet with a tool having a flat edge to smooth out trapped bubbles between the paint film sheet and the substrate. The paint film sheet may be bonded to the corner patch by bringing the paint film sheet in intimate contact with the corner patch. Adhering the paint film sheet on the substrate may include exposing the paint film sheet to heat. Exposing the paint film sheet to heat may cause the paint film sheet to bond with the corner patch. A color of the corner patch may match a color of the paint film sheet within an engineering vehicle exterior paint color match standard. The engineering vehicle exterior paint color match standard may be based on a visual assessment at 3 feet or greater. The corner patch may be adhered on the corner of the substrate prior to adhering the paint film sheet. The paint film sheet may be adhered on the corner of the substrate prior to adhering the corner patch. The method may further include forming the corner patch in the paint film based on measured dimensions of the corner of the substrate.

According to some aspects, a cosmetic paint film adhered onto an exterior panel of a motor vehicle is described, the cosmetic paint film including: a corner patch adhered onto a corner of an exterior panel of the motor vehicle; and a paint film sheet adhered onto a portion of the exterior panel adjacent to the corner, the paint film sheet having a corner relief pattern corresponding to a recess along an edge of the paint film sheet, the paint film sheet arranged such that at least a portion of the corner is within corner relief pattern, wherein at the paint film sheet overlaps and is bonded with the corner patch to provide a continuous paint film over at least the corner of the exterior panel. The exterior panel may be a hood, spoiler, door, or bumper of a car. The motor vehicle may be a car, truck, airplane or boat. The corner patch may have a first thickness, and the paint film sheet may have a second thickness, wherein the first thickness may be less than the second thickness. A ratio of the first thickness relative the second thickness ranges between 1:4 and 3:4. The first thickness may range between 100-500 microns, and the second thickness may range between 50 and 200 microns. A color of the corner patch may match a color of the paint film sheet within an engineering vehicle exterior paint color match standard. The engineering vehicle exterior paint color match standard may be based on a visual assessment at 3 feet or greater.

These and other aspects and advantages are described herein.

### BRIEF DESCRIPTION OF THE DRAWINGS

Novel features of embodiments described herein are set forth with particularity in the appended claims. A better understanding of the features and advantages of the embodiments may be obtained by reference to the following detailed description that sets forth illustrative embodiments and the accompanying drawings.

FIG. 1 illustrates a cross-section view of example paint film.

FIGS. 2A and 2B illustrate a plan view of portion of an example paint film sheet having a corner relief pattern: FIG. 2A shows various features of the paint film; and FIG. 2B shows a close-up view of the corner relief pattern.

FIGS. 2C and 2D illustrate section views of a portion of an exemplary substrate covered with the paint film of FIGS. 2A and 2B: FIG. 2C shows an edge of the substrate covered with a flap section of the paint film; and FIG. 2D shows a corner of the substrate partially covered with a protrusion portion of a corner relief pattern of the paint film.

FIGS. 3A-3C illustrate various views of another paint film sheet and a corner patch on a substrate: FIG. 3A shows the paint film sheet positioned on the substrate such that a corner relief pattern is aligned with a corner of the substrate: FIG. 3B shows the corner patch adhered onto the corner of the substrate; and FIG. 3C shows the paint film sheet adhered onto the substrate and bonded with the corner patch.

FIGS. 4A and 4B illustrate another example paint film sheet and corner patch: FIG. 4A shows the corner patch adhered to the corner; and FIG. 4B shows the paint film sheet adhered to the substrate and bonded with the corner patch.

FIG. 5 illustrates a flowchart indicating an example method of applying a paint film on a substrate having a corner.

FIG. 6 illustrates a plan view of an example paint film corner patch.

FIG. 7 illustrates a top view of the corner patch of FIG. 6 when used in conjunction with the example paint film sheet of FIG. 2B over the corner of a substrate.

FIG. 8A illustrates a plan view of an example paint film corner patch and highlights a narrow region of the corner patch.

FIG. 8B illustrates a side cross-sectional view of the narrow region of the corner patch of FIG. 8A wrapped around a corner edge of a substrate.

FIG. 9A illustrates a plan view of an example paint film corner patch and highlights a wide region of the corner patch.

FIG. 9B illustrates a side cross-sectional view of the wide region of the corner patch of FIG. 9A wrapped around a corner edge of a substrate.

FIG. 10 illustrates an example paint film having a simple relief cut of the type typically used when installing paint film on a corner a car hood part.

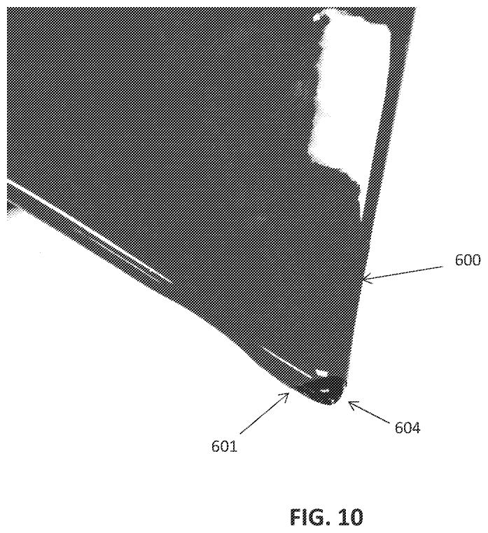

### DETAILED DESCRIPTION

Described herein are improved methods of applying a paint film on a substrate, especially on sharp corners and other prominent surfaces features of the substrate. The methods may be well suited for applying paint films to cosmetic surfaces of motorized vehicles such as automobiles, airplanes, and boats. The disclosed paint film methods can advantageously provide a smooth and continuous coating with improved cosmetic and protective qualities compared to paint films formed using conventional techniques.

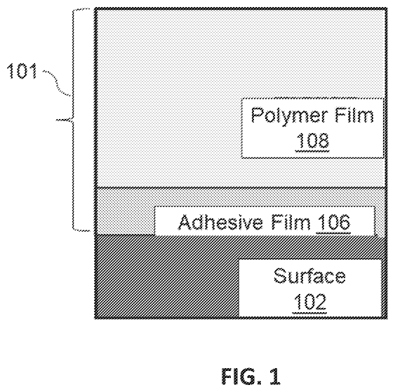

The paint films described herein may be made of polymer material(s) and be manufactured as thin sheets. In some cases, the paint films may include one or more adhesive layers. FIG. 1 illustrates an exemplary paint film 101 on a surface 102 (e.g., a surface of a motorized vehicle). The paint film 101 includes a polymer film layer 108 and an adhesive layer 106. The paint film 101 can be a polymer laminate. In one embodiment, the polymer film layer 108 can be a polyurethane or a polyacrylate. For example, the polymer film layer 108 can be a polymer containing urethane (also known as carbamate) linkages, urea linkages, or combinations thereof (i.e., in the case of poly(urethane-urea)s). Thus, the polymer film layer 108 can contain at least urethane linkages, urea linkages, or combinations thereof. In some embodiments, the polymer film layer 108 can have a polymeric backbone with at least 40%, at least 60%, or at least 80% urethane and/or urea repeat linkages formed in-situ during the polymerization process. The adhesive layer 106 can include a pressure-sensitive adhesive. In some embodiments, the pressure sensitive adhesive can include (meth)acrylate (i.e., acrylate and methacrylate). For example, the pressure sensitive adhesive can include 2-ethyl hexyl acrylate, vinyl acetate, and acrylic acid monomers polymerized and cross-linked with conventional aluminum or melamine crosslinkers. In some embodiments, the adhesive layer 106 can include synthetic and natural rubbers, poly butadiene and copolymers thereof, polyisoprene and copolymers thereof, and/or silicones (e.g., polydimethylsiloxane and polymethylphenylsiloxane). In some embodiments, the paint film 101 can additionally include a pigmented basecoat. Additional features of an exemplary paint film are described in U.S. Publication No. 20190161646, titled “Paint Film Appliques with Reduced Defects, Articles and Methods,” the entirety of which is incorporated by reference herein.

Methods of applying the paint films described herein may include positioning the paint film (e.g., paint film 101) onto surfaces a substrate such that the adhesive layer adheres thereto. In some cases, a fluid layer (e.g., water) may be provided between the paint film and the substrate during manufacturing to help positioning and air removal prior to the adhesion of the paint film sheet onto the substrate. In other cases, the paint film may be applied with a dry application process.

The methods described herein can advantageously enable the installation of a paint film with improved cosmetic and protective qualities. According to some aspects, the methods described herein involve forming a corner relief pattern in a paint film that is shaped to accommodate a corner tip and designed to bond with a corner patch. The corner patch may be a piece of film that is made of the same material as the paint film. The paint film and corner patch may be made of materials configured to bond with each other when brought into intimate contact with each other. Once bonded together, the paint film and the corner patch may cooperate to form a protective and aesthetically appealing coating to the corner of the substrate.

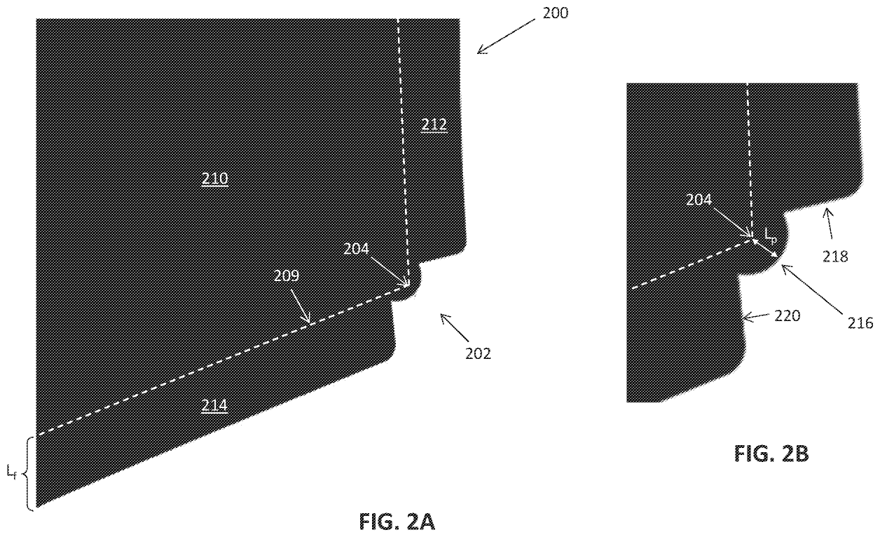

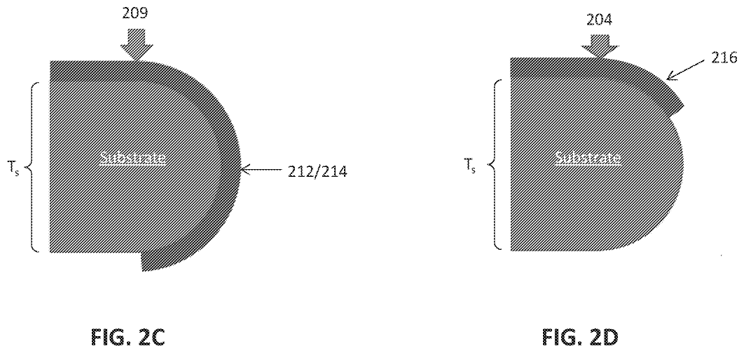

FIG. 2A illustrates a plan view of a portion of an exemplary paint film sheet 200 having a corner relief cut pattern 202. FIG. 2B illustrates a close-up view of the corner relief cut pattern 202. The dotted line 209 indicates where an edge of an underlying surface of a substrate would be, including a corner 204 of the substrate. The paint film sheet 200 can be cut in accordance with the dimensions of the corner 204 of the substrate. The paint films herein may be configured to cover a corner 204 having any angle, for example, an acute angle (less than 90 degrees), right angle (90 degrees), obtuse angle (>90 degrees), or reflex angle (>180 degrees). The paint films herein may also be configured to cover a corner 204 having any thickness. For stamped metal panels, the thickness of a panel typically depends upon the thickness of the sheet metal and how tightly the edges are folded over. This can be any thickness, but is often between about 0.5 mm and about 20 mm.

In the example shown, the paint film sheet 200 includes a main section 210, a first flap section 212, and a second flap section 214. The main section 210 can be configured to cover a first surface of the substrate, the second section 212 can be configured to cover a second surface of the substrate, and a third section 214 can be configured to cover a third surface of the substrate. For example, the main section 210 may be configured to cover a top surface of the substrate, and the first 212 and second 214 flap sections can be configured to fold over and onto edge surfaces of the substrate adjacent to the corner 204.

The corner relief pattern 202 can correspond to a recess that is cut along an edge of the paint film 202. The corner relief pattern 202 can have a shape that is configured to cover at least part of the corner 204 of the substrate. In this case, the corner relief pattern 202 includes a protrusion portion 216 between a first flap edge 218 and a second flap edge 220 of the paint film 200. The protrusion portion 216 can protrude outward relative to the first 218 and second 220 flap edges. The first 218 and second 220 flap edges can be set back from the adjacent panel edges 209 as shown to allow protrusion portion 216 to have an included angle that is greater than the angle of the panel corner 204. In some embodiments, the setback is less than a length of the protrusion portion 216 (from the substrate corner 204 and the edge of the protrusion portion 216.) The shape of the protrusion portion 216 and the extent to which the protrusion portion 216 protrudes (e.g., height) can depend on the geometry of the corner tip. For example, a protrusion portion 216 may be narrower and/or protrude farther when configured to cover sharper corners compared to shallower corners.

In some cases, the protrusion portion 216 may have a curved outer edge, as shown in the example of FIGS. 2A and 2B. This may allow for a smoother and less apparent blending of the paint film when bonded with a corresponding corner patch, as describe herein. In other examples, the protrusion portion 216 may have a differently shaped outer edge. For example, the protrusion portion 216 may include a pointed outer edge.

The corner relief pattern 202 may be formed within the paint film sheet 200 prior to adhering the paint film sheet 200 onto the corner of a substrate. In some cases, the corner relief pattern 202 is formed by cutting the paint film sheet 200. In other cases, the paint film sheet 200 is manufactured with the corner relief pattern 202 formed therein.

The dimensions of corner relief cut pattern 202 may vary depending on corner geometry of the substrate. For example, a length Lf of the flap section 212 or 214 (from the substrate edge 209 and the edge of the flap sections 212 or 214) and a length of the protrusion portion 216 (from the substrate corner 204 and the edge of the protrusion portion 216) can depend on the thickness of the substrate and whether the substrate edge has a curvature.

FIG. 2C illustrates a close-up section view of an edge of an exemplary substrate covered with a flap section 212 or 214 of the paint film sheet 200. The thickness Tₛ of the 30) substrate may vary. However, typical automotive body panel edges have a thickness ranging between about 4 mm and 10 mm. In this case, the edge of the substrate has a curved cross-section with a hemispherical cross-section. In some examples, the length Lf of the flap section 212 or 214 can be (½)(π)Tₛ. FIG. 2D illustrates a close-up section view of the corner of a substrate covered with the protrusion portion 216 of the paint film sheet 200. The length Lₚ of the protrusion portion 216 may be less than the length Lf of the flap section 212 or 214. In some examples, the length Lₚ of the protrusion portion 216 can be (⅛)(π)Tₛ.

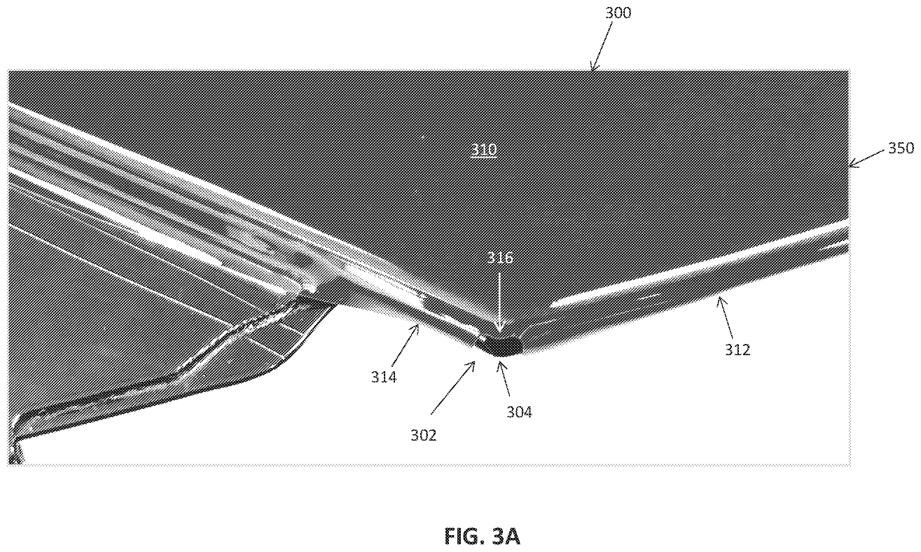

FIGS. 3A-3C illustrate an exemplary paint film sheet 300 having a corner relief pattern 302, similar to the paint film sheet 200, applied to a corner of a substrate with a corner patch. In this example, the substrate is a car hood. FIG. 3A shows the paint film sheet 300 positioned on the corner of the substrate showing the corner relief pattern 302 aligned over the corner tip 304. Note that FIG. 3A shows the paint film sheet 300 on the substrate for illustrative purposes. In practice, the paint film sheet 300 may not be applied onto substrate until after a corner patch has been applied to the substrate.

As shown in FIG. 3A, a main section 310 of the paint film sheet 300 can be configured to cover a main surface 350 (e.g., outer surface) of the substrate, a first flap section 312 can be configured to bend around and cover a first edge surface 352 of the substrate, and a second flap section 314 can be configured to bend around and cover a second edge surface 354 of the substrate. The protrusion portion 316 of the corner relief cut pattern 302 can be configured to extend past the main surface 350 of the substrate and over at least a portion of the corner tip 304 without deforming the paint film sheet 300. For example, a user may not need to substantially deform the paint film sheet 300 over the corner tip 304, thereby reducing the chances of thinning the paint film sheet 300.

A thickness of the paint film sheet 300 may vary depending on properties (e.g., type of material, color and/or opacity) of the paint film sheet 300 and/or the surface of the substrate. For example, a lighter colored paint film sheet 300 may need to be thicker than a darker colored paint film sheet 300, especially if the underlying surface of the substrate is dark in color. In some examples, the paint film sheet 300 has a thickness ranging between any two of the following values: 100 micrometers (microns), 150 microns, 200 microns, 250 microns, 300 microns, 350 microns, 400 microns, 450 microns, and 500 microns.

FIG. 3B shows the substrate without the paint film sheet 300 and after a corner patch 330 is applied to the corner tip 304 of the substrate. The corner patch 330 may be a piece of polymer film and adhesive, similar to the paint film sheet 300. In some cases, the corner patch 330 may be made of a same material(s) and/or have the same color as the paint film sheet 300. A thickness of the corner patch may vary depending on properties (e.g., type of material, color and/or opacity) of the corner patch 330 and/or properties of the substrate. In some examples, the corner patch 330 has a thickness ranging between any two of the following values: 50 microns, 60 microns, 70 microns, 80 microns, 90 microns, 100 microns, 150 microns, and 200 microns.

The corner patch 330 may be applied onto the substrate using any of various techniques. In some cases, the corner patch 330 is simply applied over the corner tip 304 and pressure is applied to cause the corner patch 330 to adhere and conform to the shape of the corner tip 304. In some cases, a fluid layer (e.g., water) may be provided between the paint film sheet 300 and the substrate to help assist with positioning and air removal prior to the adhesion of the paint film sheet 300 to the substrate. In other instances, the paint film sheet 300 may be applied with a dry application process (i.e., with substantially no fluid layer).

FIG. 3C shows the substrate after the paint film sheet 300 has been adhered onto the substrate and coupled with the corner patch 330. During the adhesion process, heat may be applied to the paint film sheet 300 to enable the paint film sheet 300 to bond with substrate and the corner patch 330, thereby creating a conformal coating over at least the corner tip 304 of the substrate. Heat may soften the polymer material of the paint film sheet 300 to reduce the force required to stretch the paint film sheet 300. Thus, the elevated temperature may enable increased conformability of the paint film sheet 300, and allow the paint film sheet 300 to come into intimate contact with the substrate and the corner patch 330. Heat may also allow the surfaces of substrate (and corner patch 330) to “wet out” by the adhesive of the paint film sheet 300 to improve bonding of the paint film sheet 300. In this context. “wetting out” may refer to adhesive flowing and covering the substrate (and corner patch 330) to maximize the contact area and the attractive forces between the adhesive the substrate (and corner patch 330). In some cases, fluid (e.g., water) may be used to assist the adhesive to “wet out” the substrate surface as it may enable the adhesive and substrate to be brought into close contact without entrapping air. Entrapped air may prevent or reduce adhesion in an affected area, and may result in cosmetically unattractive air bubbles. Most (if not all) of the fluid may be displaced from between the adhesive and substrate when the paint film sheet 300 is laminated down. An extremely thin layer of fluid may quickly be absorbed by the paint film sheet 300 and be transmitted to the environment as water vapor. The adhesive may be in full contact with the substrate, and thus it may fully wet out. Substantially any elevated temperature may enable increased conformability and adhesion, although it is preferable to stay below the melting point of the material of the paint film sheet 300 and/or corner patch 330, such as any individual layers and/or adhesives). For example, it may be preferable to heat the paint film sheet 300 and/or corner patch 330 to be no greater than about 70% of the melting point of any of the material(s) of the paint film sheet 300 and/or corner patch 330.

Note that in some cases, the paint film sheet 300 may be applied prior to the corner patch 330. Heating of the paint film sheet 300 and/or the corner patch 330 can similarly bond the two together to create a conformal coating over at least the corner tip 304 of the substrate. However, this configuration may be less desirable, depending on the dimensions of a paint film sheet and corner patch. For example, if the corner patch 330 is applied under the paint film sheet 300, most of the corner patch 330, including edges of the corner patch 330, is covered by the paint film sheet 300, making the corner patch 330 less noticeable. If the corner patch 330 is applied over the paint film sheet 300, most of the corner patch 330, including edges of the corner patch 330, is exposed, which may make the corner patch 330 more noticeable.

As shown, the material of the paint film sheet 300 blends with the material of the corner patch 330 to form a smooth and continuous coating on the substrate. For example, the cutout features of the corner relief cut pattern 302, including the protrusion portion 316, may no longer be visibly apparent from a particular distance (e.g., at least 3 feet away). Since the paint film sheet 300 was not substantially thinned in the region around the corner tip 304, the result is a robustly protective paint film around the corner 304 of the substrate. In some cases, the color of the corner patch 330 and the paint film sheet 300 are substantially the same so that they render a visually continuously color around the corner tip 304.

In some cases, a thickness of the corner patch 330 relative to a thickness of the paint film sheet 300 may play a role in the appearance and/or tactile quality of the paint film around the corner tip 304. For example, it may be beneficial, in some cases, for the corner patch 330 to have a thickness that is equal to or less than the thickness of the paint film sheet 300 since the two overlap to some extent. In some case, it may be preferable for the corner patch 330 to be thinner than the paint film sheet 300. Having a corner patch 330 that is too thick may cause an overlap between the paint film sheet 300 and the corner patch 330 to be visibly apparent and/or tactilely thicker. However, a corner patch 330 that is too thin may change visual characteristics of the corner patch 330, such as making the corner patch 330 less opaque, which may cause an undesirable visual difference between the corner patch 330 and the paint film sheet 300. Further, a very thin corner 330 patch may be difficult for a user to handle during the adhering process. In some examples, a ratio of the thickness of the corner patch 330 with respect to the thickness of the paint film sheet 300 ranges between any two of the following values: 1:4, 1:3, 1:2, 2:3, 3:4, and 1:1.

The resultant paint film may have cosmetic characteristics in accordance with one or more engineering standards. One such engineering standard is the Jaguar Land Rover Limited—Engineering Standard (STJLR.01.5026) for “Exterior Paint: Cosmetic Appearance.” which sets out standards for areas of exterior paint for motor vehicles where: class “A”—high visibility areas, class “B”—low visibility area, and class “C”—hidden. In some embodiments, the applied paint films described herein meet one or more criteria of class “A” of such standard. For example, visual class “A” color match criteria (also referred to as “4” or “5” rated color match) are as follows: “5” rated—there is no discernible color difference between a master and sample when placed edge to edge), or “4” rated—there is a very slight difference when viewed edge to edge with no discernible difference when viewed with a gap of 3 mm. Under such criteria, in some embodiments, the applied paint film sheet 300 and corner patch 330 meets visual class “A” standard for color matching. In some cases, a color match standard is based whether there is a discernible difference at least 3 feet away.

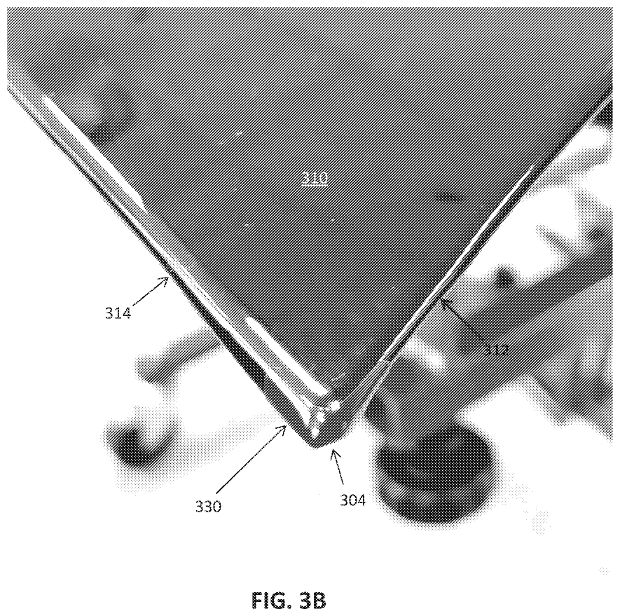

FIGS. 4A and 4B illustrate another substrate 410 having a corner being covered with another exemplary paint film. As shown in FIG. 4A, the substrate 410 includes an edge having a corner 404. A corner patch 430 having a size and shape that covers at least a portion of the corner 404 is adhered on the substrate 410. In this case, the corner patch 430 has a rectangular shape. FIG. 4B, shows a paint film sheet 400 being applied over the substrate 410. The paint film sheet 400 has a corner relief pattern 402 that is sized and shaped to partially overlap the corner patch 430. In this case, the corner relief pattern 402 has a rectangular shape to match the rectangularly shaped corner patch 430. Once applied onto the substrate 410 heat may be applied to the paint film sheet 400 and corner patch 430 to bond the two together.

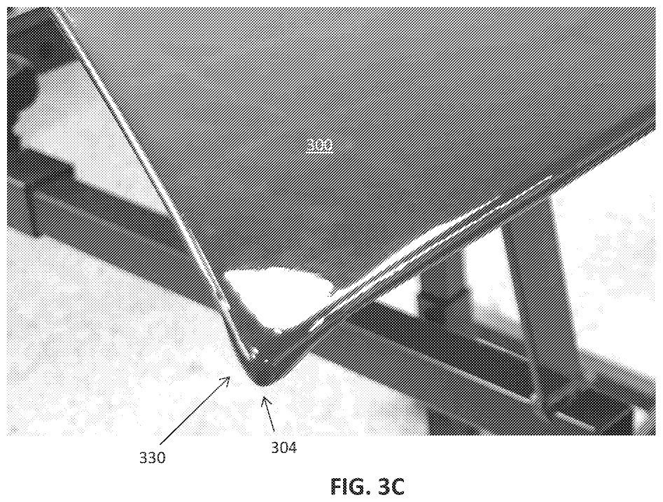

FIG. 5 is a flowchart illustrating an exemplary method of applying a paint film on a substrate having a corner. At 500, a corner relief pattern is formed in a paint film sheet to accommodate the corner of substrate. In some cases, the corner relief pattern may correspond to a recessed portion along an edge of the paint film sheet. The corner relief pattern may be cut into the film. The corner relief pattern may allow the paint film sheet to cover at least a portion of corner, such as a tip (e.g., apex) of the corner. In some cases, the corner relief pattern may be cut into the paint film sheet by a user (e.g., as part of the paint film application process).

In other cases, the paint film sheet may include the corner relief pattern already formed therein. Such pre-formed corner relief pattern may be created during a manufacturing process. In such cases, the paint film may be pre-cut into shapes that fit the dimensions of a substrate (e.g., an automotive panel). As the dimensions (e.g., angles) at the corners of the pre-cut paint sheet will be known, the corner relief pattern can be cut into the paint sheet based on the known dimensions. Corner patches can be cut at the same time having dimensions sufficient to cover the portions of the substrate that the corner relief pattern leaves uncovered.

At 502, a corner patch having a size and shape configured to cover at least a portion of the corner is formed. The corner patch may be made of a paint film. In some cases, the corner patch is made of the same material as the paint film sheet. In some cases, a thickness of the corner patch may be less than a thickness of the paint film sheet.

At 504, the corner patch is adhered to the corner of the substrate. This may involve positioning a corner patch paint film on the corner and applying an even pressure on a top surface of the corner patch paint film until it is cosmetically smooth and free of underlying air bubbles. In some cases, heat is applied to the corner patch.

At 506, the paint film sheet is adhered to the substrate. This may involve applying an even pressure on a top surface of the paint film sheet until it is cosmetically smooth and free of underlying air bubbles. The corner relief pattern of the paint film sheet may be aligned to partially overlap with the corner patch on the corner. The paint film sheet may be placed in intimate contact with the corner patch to cause them to bond together. In some cases, heat is applied to the paint film sheet and/or the corner patch to assist in bonding the paint film sheet and the corner patch together where they overlap. The resultant paint film may be smooth and continuous over the corner. In some cases, the paint film sheet and the corner patch are sufficiently color matched that there is no discernible color difference between the paint film sheet and the corner patch once applied on the substrate (e.g., from 3 feet away or greater).

Note that in some cases, the paint film sheet may be applied (506) prior to applying the corner patch (502). Heating of the paint film sheet and/or the corner patch can similarly assist in bonding the two together to create a conformal coating over at least the corner tip 304 of the substrate.

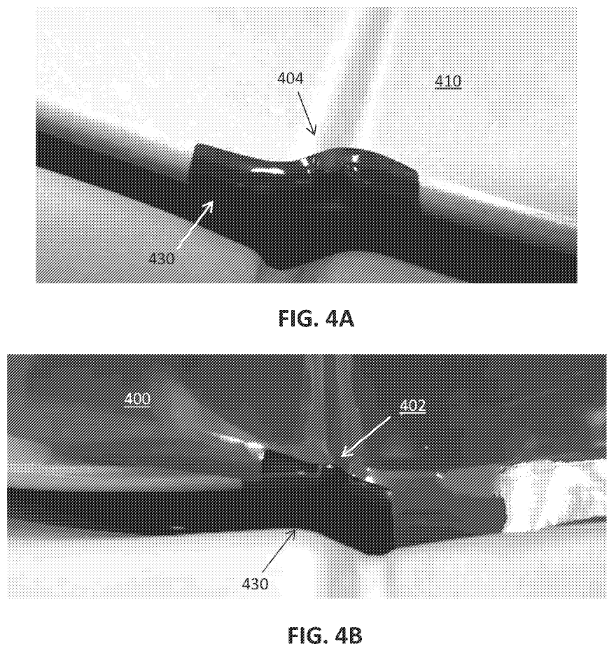

FIG. 6 illustrates a plan view of an example paint film corner patch 620. As shown, corner patch 620 is generally dog bone shaped with a narrow region 622 spanning between two wide regions 624. In some embodiments, the overall length of corner patch 622 is between about 2π×Lₚ and about 3π×Lₚ, where Lₚ is the length of the protrusion portion 216 as shown in FIG. 2B.

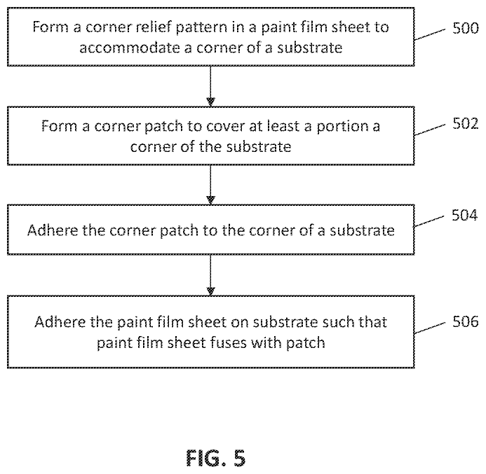

FIG. 7 illustrates a top view of corner patch 622 when used in conjunction with paint film sheet 210 over the corner of a substrate. In some embodiments, film sheet 210 overlaps each end of corner patch 622 by about 10% to about 40% of patch 622.

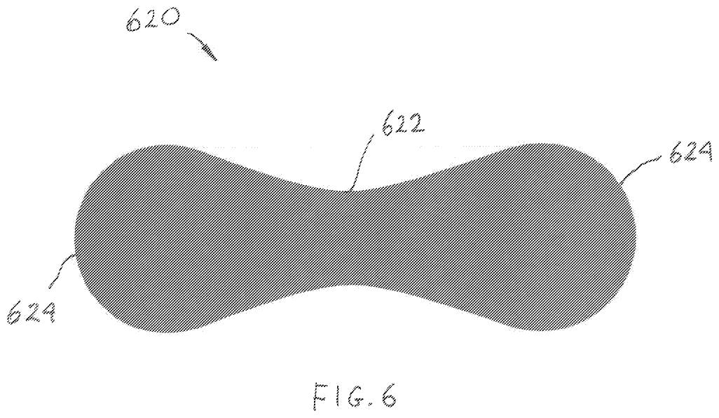

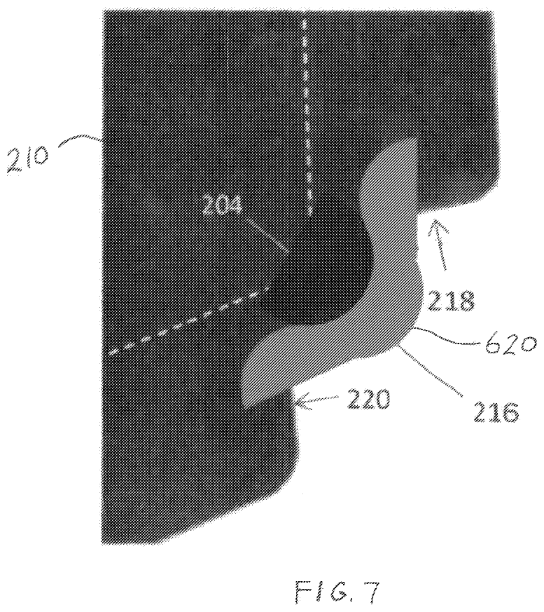

FIG. 8A illustrates a plan view of corner patch 620 and highlights narrow region 622 of the corner patch. FIG. 8B illustrates a side cross-sectional view of narrow region 622 wrapped around a corner edge of a substrate.

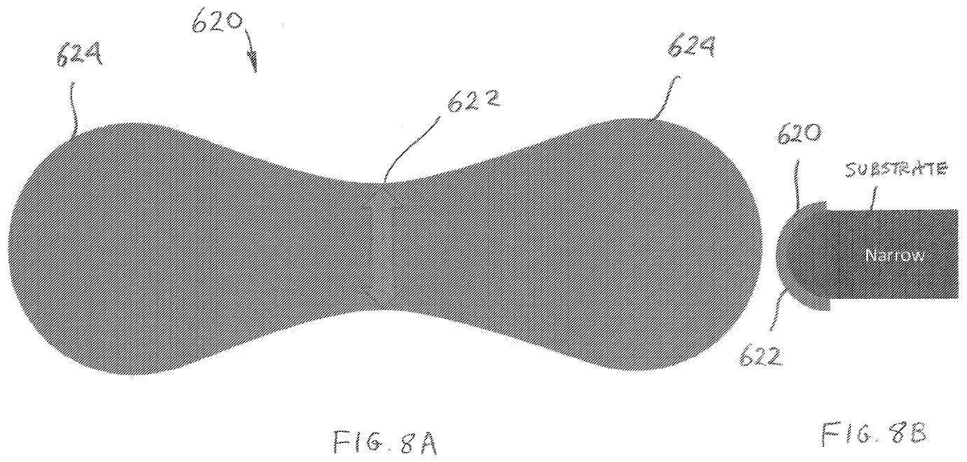

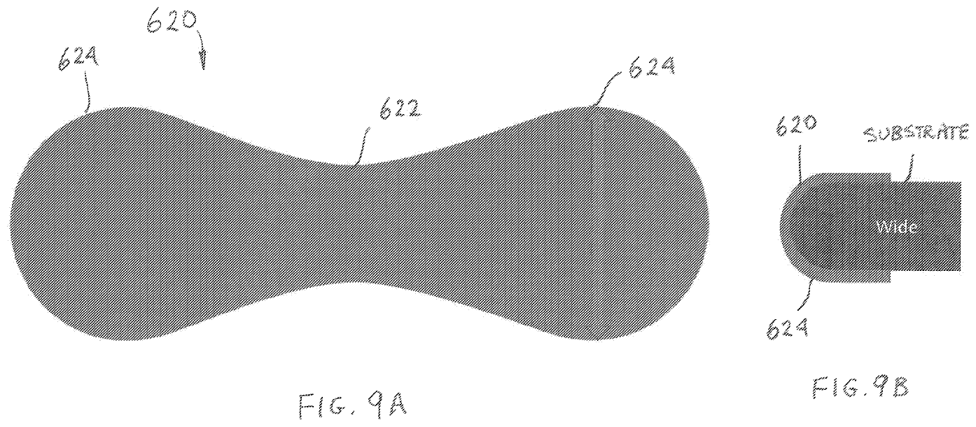

FIG. 9A illustrates a plan view of corner patch 620 and highlights wide region 624 of the corner patch. FIG. 9B illustrates a side cross-sectional view of wide region 624 wrapped around a corner edge of the substrate.

When a feature or element is herein referred to as being “on” another feature or element, it can be directly on the other feature or element or intervening features and/or elements may also be present. In contrast, when a feature or element is referred to as being “directly on” another feature or element, there are no intervening features or elements present. It will also be understood that, when a feature or element is referred to as being “connected”, “attached” or “coupled” to another feature or element, it can be directly connected, attached or coupled to the other feature or element or intervening features or elements may be present. In contrast, when a feature or element is referred to as being “directly connected”. “directly attached” or “directly coupled” to another feature or element, there are no intervening features or elements present. Although described or shown with respect to one embodiment, the features and elements so described or shown can apply to other embodiments. It will also be appreciated by those of skill in the art that references to a structure or feature that is disposed “adjacent” another feature may have portions that overlap or underlie the adjacent feature.

Terminology used herein is for the purpose of describing particular embodiments only and is not intended to be limiting of the invention. For example, as used herein, the singular forms “a”. “an” and “the” are intended to include the plural forms as well, unless the context clearly indicates otherwise. It will be further understood that the terms “comprises” and/or “comprising.” when used in this specification, specify the presence of stated features, steps, operations, elements, and/or components, but do not preclude the presence or addition of one or more other features, steps, operations, elements, components, and/or groups thereof. As used herein, the term “and/or” includes any and all combinations of one or more of the associated listed items and may be abbreviated as “/”.

Spatially relative terms, such as “under”. “below”. “lower”. “over”. “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if a device in the figures is inverted, elements described as “under” or “beneath” other elements or features would then be oriented “over” the other elements or features. Thus, the exemplary term “under” can encompass both an orientation of over and under. The device may be otherwise oriented (rotated 90 degrees or at other orientations) and the spatially relative descriptors used herein interpreted accordingly. Similarly, the terms “upwardly”, “downwardly”, “vertical”, “horizontal” and the like are used herein for the purpose of explanation only unless specifically indicated otherwise.

Although the terms “first” and “second” may be used herein to describe various features/elements (including steps), these features/elements should not be limited by these terms, unless the context indicates otherwise. These terms may be used to distinguish one feature/element from another feature/element. Thus, a first feature/element discussed below could be termed a second feature/element, and similarly, a second feature/element discussed below could be termed a first feature/element without departing from the teachings of the present invention.

Throughout this specification and the claims which follow, unless the context requires otherwise, the word “comprise”, and variations such as “comprises” and “comprising” means various components can be co-jointly employed in the methods and articles (e.g., compositions and apparatuses including device and methods). For example, the term “comprising” will be understood to imply the inclusion of any stated elements or steps but not the exclusion of any other elements or steps.

In general, any of the apparatuses and methods described herein should be understood to be inclusive, but all or a sub-set of the components and/or steps may alternatively be exclusive, and may be expressed as “consisting of” or alternatively “consisting essentially of” the various components, steps, sub-components or sub-steps.

As used herein in the specification and claims, including as used in the examples and unless otherwise expressly specified, all numbers may be read as if prefaced by the word “about” or “approximately.” even if the term does not expressly appear. The phrase “about” or “approximately” may be used when describing magnitude and/or position to indicate that the value and/or position described is within a reasonable expected range of values and/or positions. For example, a numeric value may have a value that is +/−0.1% of the stated value (or range of values), +/−1% of the stated value (or range of values), +/−2% of the stated value (or range of values), +/−5% of the stated value (or range of values), +/−10% of the stated value (or range of values), etc. Any numerical values given herein should also be understood to include about or approximately that value, unless the context indicates otherwise. For example, if the value “10” is disclosed, then “about 10” is also disclosed. Any numerical range recited herein is intended to include all sub-ranges subsumed therein. It is also understood that when a value is disclosed that “less than or equal to” the value, “greater than or equal to the value” and possible ranges between values are also disclosed, as appropriately understood by the skilled artisan. For example, if the value “X” is disclosed the “less than or equal to X” as well as “greater than or equal to X” (e.g., where X is a numerical value) is also disclosed. It is also understood that the throughout the application, data is provided in a number of different formats, and that this data, represents endpoints and starting points, and ranges for any combination of the data points. For example, if a particular data point “10” and a particular data point “15” are disclosed, it is understood that greater than, greater than or equal to, less than, less than or equal to, and equal to 10 and 15 are considered disclosed as well as between 10 and 15. It is also understood that each unit between two particular units are also disclosed. For example, if 10 and 15 are disclosed, then 11, 12, 13, and 14 are also disclosed.

Although various illustrative embodiments are described above, any of a number of changes may be made to various embodiments without departing from the scope of the invention as described by the claims. For example, the order in which various described method steps are performed may often be changed in alternative embodiments, and in other alternative embodiments one or more method steps may be skipped altogether. Optional features of various device and system embodiments may be included in some embodiments and not in others. Therefore, the foregoing description is provided primarily for exemplary purposes and should not be interpreted to limit the scope of the invention as it is set forth in the claims.

The examples and illustrations included herein show, by way of illustration and not of limitation, specific embodiments in which the subject matter may be practiced. As mentioned, other embodiments may be utilized and derived there from, such that structural and logical substitutions and changes may be made without departing from the scope of this disclosure. Such embodiments of the inventive subject matter may be referred to herein individually or collectively by the term “invention” merely for convenience and without intending to voluntarily limit the scope of this application to any single invention or inventive concept, if more than one is, in fact, disclosed. Thus, although specific embodiments have been illustrated and described herein, any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

What is claimed is:

1. A method of applying a paint film on a substrate, the method comprising:
adhering a corner patch on at least a portion of a corner of the substrate; and
adhering a paint film sheet on the substrate such that the corner is within a corner relief pattern of the paint film sheet, the corner relief pattern corresponding to a recess along an edge of the paint film sheet, wherein paint film sheet partially overlaps with and bonds with the corner patch, thereby providing a continuous paint film over at least the corner of the substrate.

2. The method of claim 1, wherein the corner patch is a paint film that is made of a same material as the paint film sheet.

3. The method of claim 1, wherein corner patch has a first thickness, and the paint film sheet has a second thickness, wherein the first thickness is less than the second thickness.

4. The method of claim 3, wherein a ratio of the first thickness relative the second thickness ranges between 1:4 and 3:4.

5. The method of claim 3, wherein the first thickness ranges between 100-500 microns, and the second thickness ranges between 50 and 200 microns.

6. The method of claim 1, wherein adhering the paint film sheet on the substrate includes applying pressure along a surface of the paint film sheet with a tool having a flat edge to smooth out trapped bubbles between the paint film sheet and the substrate.

7. The method of claim 1, wherein the paint film sheet is bonded to the corner patch by bringing the paint film sheet in intimate contact with the corner patch.

8. The method of claim 1, wherein adhering the paint film sheet on the substrate includes exposing the paint film sheet to heat.

9. The method of claim 8, wherein exposing the paint film sheet to heat causes the paint film sheet to bond with the corner patch.

10. The method of claim 1, wherein a color of the corner patch matches a color of the paint film sheet within an engineering vehicle exterior paint color match standard.

11. The method of claim 10, wherein the engineering vehicle exterior paint color match standard is based on a visual assessment at 3 feet or greater.

12. The method of claim 1, wherein the corner patch is adhered on the corner of the substrate prior to adhering the paint film sheet.

13. The method of claim 1, wherein the paint film sheet is adhered on the corner of the substrate prior to adhering the corner patch.

14. The method of claim 1, further comprising forming the corner patch in the paint film based on measured dimensions of the corner of the substrate.

15. A cosmetic paint film adhered onto an exterior panel of a motor vehicle, the cosmetic paint film comprising:
a corner patch adhered onto a corner of an exterior panel of the motor vehicle; and
a paint film sheet adhered onto a portion of the exterior panel adjacent to the corner, the paint film sheet having a corner relief pattern corresponding to a recess along an edge of the paint film sheet, the paint film sheet arranged such that at least a portion of the corner is within corner relief pattern, wherein at the paint film sheet overlaps and is bonded with the corner patch to provide a continuous paint film over at least the corner of the exterior panel.

16. The cosmetic paint film of claim 15, the exterior panel is a hood, spoiler, door, or bumper of a car.

17. The cosmetic paint film of claim 15, wherein the motor vehicle is a car, truck, airplane or boat.

18. The cosmetic paint film of claim 15, wherein corner patch has a first thickness, and the paint film sheet has a second thickness, wherein the first thickness is less than the second thickness.

19. The cosmetic paint film of claim 18, wherein a ratio of the first thickness relative the second thickness ranges between 1:4 and 3:4.

20. The cosmetic paint film of claim 18, wherein the first thickness ranges between 100-500 microns, and the second thickness ranges between 50 and 200 microns.

21. The cosmetic paint film of claim 15, wherein a color of the corner patch matches a color of the paint film sheet within an engineering vehicle exterior paint color match standard.

22. The cosmetic paint film of claim 21, wherein the engineering vehicle exterior paint color match standard is based on a visual assessment at 3 feet or greater.
